(19) United States
(12) Patent Application Publication
(10) Pub. No.: US 2025/0174926 A1
(43) Pub. Date: May 29, 2025

(54) FEMALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shingo KOBAYASHI, Mie (JP)

(21) Appl. No.: 19/026,426

(22) Filed: Jan. 17, 2025

Related U.S. Application Data
(63) Continuation of application No. PCT/JP2023/026581, filed on Jul. 20, 2023.

(30) Foreign Application Priority Data
Jul. 27, 2022 (JP) 2022-119370

(51) Int. Cl. H01R 13/187

(52) U.S. Cl. CPC H01R 13/187

(57) ABSTRACT

A female terminal includes a cylindrical connecting portion to be conductively connected to a columnar connecting portion of a male terminal, and a wire connecting portion to which a core of a wire is to be connected. The cylindrical connecting portion has a first circumferential wall portion provided by deforming one end portion of a first flat plate fitting having a strip shape to be curved into an arc shape and a second circumferential wall portion provided by deforming one end portion of a second flat plate fitting having a strip shape into an arc shape. The wire connecting portion is configured by overlapping a first other end portion which is the other end portion of the first flat plate fitting and a second other end portion which is the other end portion of the second flat plate fitting.

### CROSS REFERENCE TO RELATED APPLICATIONS

This application is a continuation application of International Patent Application No. PCT/JP2023/026581, filed on Jul. 20, 2023, which claims priority from Japanese Patent Application No. 2022-119370, filed on Jul. 27, 2022, with the Japan Patent Office, the disclosures of which are incorporated herein in their entireties by reference.

### TECHNICAL FIELD

The present disclosure relates to a female terminal.

### BACKGROUND

An electric connection structure formed by male and female terminals, the male terminal being called a pin terminal or the like and having a generally columnar-shaped columnar connecting portion and the female terminal being called a sleeve terminal or the like and having a generally cylindrical-shaped cylindrical connecting portion, has been conventionally used. In a case where the cylindrical connecting portion of the female terminal is cylindrically cut and manufactured by cutting machining, processability is poor, and manufacturing cost increases. Therefore, Japanese Patent Laid-open Publication No. 2013-187171 proposes cylindrically curving a metal flat plate by press working to manufacture the cylindrical connecting portion, thereby improving processability and reducing manufacturing cost.

### SUMMARY

However, in order to deal with a recent increase in current in on-board devices, a metal flat plate constituting a female terminal has been increased in plate thickness, so that it is difficult to cylindrically bend a metal flat plate having a large plate thickness to manufacture the female terminal of Japanese Patent Laid-open Publication No. 2013-187171. Moreover, in the structure of Japanese Patent Laid-open Publication No. 2013-187171, only a partial region in the circumferential direction of the cylindrical connecting portion is directly coupled to a wire connecting portion to which a core of a covered wire is to be connected. As a result, a conducting path to the wire connecting portion is long in the remaining region in the circumferential direction of the cylindrical connecting portion, which leads to degradation in conduction resistance and heat radiation performance of the female terminal.

Therefore, the present disclosure has an object to provide a female terminal that is easy to manufacture even if a cylindrical connecting portion is increased in plate thickness and that can be reduced in conduction resistance and improved in heat radiation performance.

A female terminal of the present disclosure is a female terminal including a cylindrical connecting portion to be conductively connected to a columnar connecting portion of a male terminal, and a wire connecting portion to which a core of a wire is to be connected. The cylindrical connecting portion has a first circumferential wall portion provided by deforming one end portion of a first flat plate fitting having a strip shape to be curved into an arc shape and a second circumferential wall portion provided by deforming one end portion of a second flat plate fitting having a strip shape into an arc shape. The wire connecting portion is configured by overlapping a first other end portion which is the other end portion of the first flat plate fitting and a second other end portion which is the other end portion of the second flat plate fitting. The cylindrical connecting portion is configured with the first circumferential wall portion and the second circumferential wall portion arranged in an opposed manner with a gap formed therebetween by overlapping of the first other end portion of the first flat plate fitting and the second other end portion of the second flat plate fitting on each other.

The female terminal of the present disclosure is easy to manufacture even if a cylindrical connecting portion is increased in plate thickness and can be reduced in conduction resistance and improved in heat radiation performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a state where a female connector including a female terminal according to a first embodiment is fitted with a male terminal.

FIG. 2 is a vertical sectional view showing a section II-II in FIG. 1 in an enlarged manner.

FIG. 3 is an exploded perspective view of the male terminal and the female connector shown in FIG. 1.

FIG. 4 is a vertical sectional view showing a section IV-IV in FIG. 2.

FIG. 5 is a perspective view showing a female terminal according to a second embodiment, the female terminal being in a state connected to a terminal of a covered wire.

FIG. 6 is a perspective view showing a female terminal according to a third embodiment, the female terminal being in the state connected to a terminal of a covered wire.

FIG. 7 is a perspective view showing a female terminal according to a modification of the first embodiment, the female terminal being in the state connected to a terminal of a covered wire.

FIG. 8 is a perspective view showing a female terminal according to a modification of the third embodiment, the female terminal being in the state connected to a terminal of a covered wire.

FIG. 9 is a perspective view showing a female terminal according to another modification of the third embodiment, the female terminal being in the state connected to a terminal of a covered wire.

FIG. 10 is a perspective view showing a female terminal according to still another modification of the third embodiment, the female terminal being in the state connected to a terminal of a covered wire.

FIG. 11 is a perspective view showing a female terminal according to another modification of the first embodiment, the female terminal being in the state connected to a terminal of a covered wire.

FIG. 12 is a perspective view showing a female terminal according to another aspect, the female terminal being in the state connected to a terminal of a covered wire.

FIG. 13 is an exploded perspective view in the female terminal shown in FIG. 12.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

### Description of Embodiments of the Present Disclosure

First of all, aspects of the present disclosure will be listed and described.

(1) A female terminal of the present disclosure is a female terminal including a cylindrical connecting portion to be conductively connected to a columnar connecting portion of a male terminal, and a wire connecting portion to which a core of a wire is to be connected, in which the cylindrical connecting portion has a first circumferential wall portion provided by deforming one end portion of a first flat plate fitting having a strip shape to be curved into an arc shape and a second circumferential wall portion provided by deforming one end portion of a second flat plate fitting having a strip shape into an arc shape, the wire connecting portion is configured by overlapping a first other end portion which is the other end portion of the first flat plate fitting and a second other end portion which is the other end portion of the second flat plate fitting, and the cylindrical connecting portion is configured with the first circumferential wall portion and the second circumferential wall portion arranged in an opposed manner with a gap formed therebetween by overlapping of the first other end portion of the first flat plate fitting and the second other end portion of the second flat plate fitting on each other.

According to the female terminal of the present disclosure, the cylindrical connecting portion can be configured by arranging the first circumferential wall portion and the second circumferential wall portion, each of which is provided by deforming the one end portion of the metal flat plate having a strip shape to be curved into an arc shape, in an opposed manner to each other with a gap formed therebetween. This eliminates the need to bend a metal flat plate into a complete 360-degree cylindrical shape as in the conventional structure described in Japanese Patent Laid-open Publication No. 2013-187171. Even in the case where the cylindrical connecting portion is increased in plate thickness in order to deal with an increase in current, the one end portion of the first flat plate fitting and the one end portion of the second flat plate fitting can be deformed to be curved into an arc shape, so that the female terminal can be easily manufactured. In addition, the first other end portion of the first flat plate fitting with the first circumferential wall portion provided on the one end portion and the second other end portion of the second flat plate fitting with the second circumferential wall portion provided on the one end portion are overlapped on each other to configure the wire connecting portion. Therefore, the first circumferential wall portion and the second circumferential wall portion that configure the cylindrical connecting portion are as a whole directly continuous with the wire connecting portion, so that the conduction resistance of the female terminal can be reduced and the heat radiation performance can be improved as compared with the case where only a partial region of the cylindrical connecting portion is connected to the wire connecting portion as in the conventional structure described in Japanese Patent Laid-open Publication No. 2013-187171.

Note that the first flat plate fitting and the second flat plate fitting may be separate from each other or may be coupled to each other on the respective other end portion sides. The cylindrical connecting portion may be arranged to open toward a front side in a spacing direction from the wire connecting portion or may be arranged to open on both sides in the direction orthogonal to the spacing direction from the wire connecting portion. With the expression that “the first other end portion and the second other end portion are overlapped”, the first other end portion and the second other end portion do not need to be in close contact over the entire surface but should only be arranged in proximity in an opposed manner to each other, and a state where the first other end portion and the second other end portion are opposed partially or entirely with a gap formed therebetween is also included.

(2) Preferably, in (1) above, the first flat plate fitting and the second flat plate fitting are configured by a metal flat plate having a strip shape in which the first other end portion and the second other end portion are coupled to each other with a coupling portion interposed therebetween, the first circumferential wall portion of the first flat plate fitting and the second circumferential wall portion of the second flat plate fitting are provided respectively in both end portions of the metal flat plate, and the coupling portion of the metal flat plate is bent in a plate thickness direction to overlap the first other end portion of the first flat plate fitting and the second other end portion of the second flat plate fitting on each other to configure the wire connecting portion, and the first circumferential wall portion and the second circumferential wall portion provided in both the end portions are arranged in an opposed manner to each other with a gap formed therebetween to configure the cylindrical connecting portion.

The cylindrical connecting portion and the wire connecting portion can be easily manufactured merely by press working the first and second circumferential wall portions in both the end portions of the metal flat plate having a strip shape and bending the coupling portion provided in the central portion of the strip plate fitting in the plate thickness direction to fold the strip plate fitting in half in the length direction, and productivity and handling performance can be improved further.

(3) Preferably, in (1) or (2) above, the female terminal includes a cylindrical contact member arranged on an inner circumferential side of the cylindrical connecting portion, and the contact member has a plurality of spring contact portions configured to bias and come into contact with an outer circumferential surface of the columnar connecting portion of the male terminal inserted into the cylindrical connecting portion.

Since the contact member separate from the first circumferential wall portion and the second circumferential wall portion that configure the cylindrical connecting portion is included, it is easy to control a contact pressure of the cylindrical connecting portion against the male terminal. In particular, it is easy to decrease the contact pressure, and an insertion force when the female and male terminals are fitted with each other can be reduced. Moreover, the contact resistance can also be reduced by providing a plurality of spring contact portions to increase contacts.

(4) Preferably, in any one of (1) to (3) above, the female terminal further includes a cylindrical contact member arranged on an inner circumferential side of the cylindrical connecting portion, and an opening prevention member configured to restrict the first circumferential wall portion and the second circumferential wall portion mounted on an outer circumferential side of the cylindrical connecting portion from being displaced in a direction opposite to an opposed direction of the first circumferential wall portion and the second circumferential wall portion, in which the contact member has a plurality of spring contact portions configured to bias and come into contact with an outer circumferential surface of the columnar connecting portion of the male terminal inserted into the cylindrical connecting portion.

Since the contact member separate from the first circumferential wall portion and the second circumferential wall portion that configure the cylindrical connecting portion is included, it is easy to control a contact pressure of the cylindrical connecting portion against the male terminal. In particular, it is easy to decrease the contact pressure, and an insertion force when the female and male terminals are fitted with each other can be reduced. Moreover, the contact resistance can also be reduced by providing a plurality of spring contact portions to increase contacts. Furthermore, deformation or the like of the contact member is also avoided advantageously as the opening prevention member is mounted on the cylindrical connecting portion to restrict the first circumferential wall portion and the second circumferential wall portion from being displaced in the direction opposite to the opposed direction.

(5) Preferably, in (4) above, the opening prevention member includes a ring member made of metal notched in a location in a circumferential direction, the cylindrical connecting portion has a plurality of engagement holes respectively provided to extend through the first circumferential wall portion and the second circumferential wall portion in a plate thickness direction, the ring member is arranged to cover the outer circumferential-side openings of the plurality of engagement holes, and a plurality of engagement portions provided on the contact member respectively engage with inner circumferential-side openings of the plurality of engagement holes to position the contact member on the cylindrical connecting portion.

The opening prevention member can be easily configured by the ring member made of metal notched in a location in the circumferential direction. Moreover, the contact member can be positioned on the cylindrical connecting portion using the plurality of engagement holes provided in the first circumferential wall portion and the second circumferential wall portion. Furthermore, the outer circumferential-side openings of the plurality of engagement holes can be covered by the ring member. Accordingly, entry of a foreign matter into the cylindrical connecting portion can be reduced or avoided while stably positioning the contact member on the cylindrical connecting portion, which can advantageously achieve stability of conduction of the female terminal.

(6) Preferably, in any one of (1) to (3) above, the first flat plate fitting has a first intermediate plate portion configured to couple the first circumferential wall portion and the first other end portion, the second flat plate fitting has a second intermediate plate portion configured to couple the second circumferential wall portion and the second other end portion, displacement of the first circumferential wall portion and the second circumferential wall portion to be spaced in a direction opposite to an opposed direction of the first circumferential wall portion and the second circumferential wall portion is allowed by elastic deformation of the first intermediate plate portion and the second intermediate plate portion, and a biasing member configured to bias the first circumferential wall portion and the second circumferential wall portion in the opposed direction is mounted on the cylindrical connecting portion.

The first circumferential wall portion and the second circumferential wall portion are pressed against the male terminal inserted into the cylindrical connecting portion through use of spring characteristics of the respective intermediate plate portions of the respective flat plate fittings. A contact pressure of the first circumferential wall portion and the second circumferential wall portion against the male terminal can be applied further by mounting the biasing member that biases the first circumferential wall portion and the second circumferential wall portion in the opposed direction on the cylindrical connecting portion. As a result, stability of conduction of the female terminal to the male terminal can be improved.

(7) Preferably, in (6) above, the biasing member includes a ring member made of metal notched in a location in the circumferential direction, and an inner circumferential surface of the ring member is pressed against and mounted on an outer circumferential surface of the cylindrical connecting portion.

Biasing means can be easily configured by the ring member made of metal notched in a location in the circumferential direction. Moreover, the ring member is mounted on the cylindrical connecting portion in the state where the inner circumferential surface of the ring member is pressed against the outer circumferential surfaces of the first and second circumferential wall portions, so that the biasing force of the ring member can be exerted uniformly over a wide area of the cylindrical connecting portion.

Accordingly, the contact pressure can be applied to the cylindrical connecting portion stably with a simple structure. Note that the ring member made of metal may be anything that is notched in a location in the circumferential direction and can be incorporated into the cylindrical connecting portion, and a known C-ring, E-ring, or the like, for example, can be employed advantageously.

(8) Preferably, in any one of (1) to (7) above, the cylindrical connecting portion is arranged to open toward a front side in a spacing direction from the wire connecting portion, and the first circumferential wall portion and the second circumferential wall portion each include a slit which extends through in a plate thickness direction to open toward the front side in the spacing direction and a plurality of divided wall portions which are spaced from each other in the circumferential direction with the slit interposed therebetween.

The first and second circumferential wall portions are divided into the plurality of divided wall portions which are respectively spaced from each other in the circumferential direction, and each of the divided wall portions is held in a cantilevered manner such that an end on the front side in the spacing direction is a free end because of the slit. Therefore, a following capability of the cylindrical connecting portion with displacement of the cylindrical connecting portion of the male terminal in the radial direction can be improved. Note that a biasing force exerted by the biasing member can be applied to each of the divided wall portions by a configuration combined with (6) or (7) above, so that improvement in the following capability of the cylindrical connecting portion with the male terminal and the contact pressure can be achieved together advantageously.

(9) Preferably, in any one of (1) to (7) above, the cylindrical connecting portion is arranged to open on both sides of the cylindrical connecting portion in an axial direction which is a direction orthogonal to a spacing direction from the wire connecting portion, the first circumferential wall portion and the second circumferential wall portion each include a slit which extends in a plate thickness direction through an intermediate portion in the axial direction and a plurality of divided wall portions which are spaced from each other in the axial direction with the slit interposed therebetween, and the plurality of divided wall portions of the first circumferential wall portion and the plurality of divided wall portions of the second circumferential wall portion are respectively arranged in an opposed manner to each other to configure a plurality of divided cylindrical portions spaced from each other in the axial direction.

The first and second circumferential wall portions are divided into the plurality of divided wall portions which are respectively spaced from each other in the axial direction of the cylindrical connecting portion, and the plurality of divided cylindrical portions arranged to be spaced in the axial direction are provided by the divided wall portions on the first circumferential wall portion side and the divided wall portions on the second circumferential wall portion side opposed to each other. Therefore, an excellent following capability with displacement of the male terminal inserted in the cylindrical connecting portion in a direction inclined with respect to the axial direction can be exercised by the divided cylindrical portions.

(10) Preferably, in (9) above, the female terminal further includes a plurality of biasing members corresponding to the plurality of divided cylindrical portions, in which each of the biasing members configured to bias the divided wall portions on the first circumferential wall portion side and the divided wall portions on the second circumferential wall portion side in the opposed direction is respectively mounted on each of the divided cylindrical portions. Mounting the biasing members individually on the plurality of divided cylindrical portions enables a contact pressure against the male terminal to be applied individually to the respective divided cylindrical portions. Accordingly, improvement in following capability because of the divided cylindrical portions and improvement in contact pressure of the respective divided cylindrical portions, that is, the cylindrical connecting portion, against the male terminal can be accomplished together. Note that members having the configuration of (7) above can be adopted as the biasing members. In that case, it is desirable to provide mounting grooves in the respective divided cylindrical portions to cause the respective ring members to be fitted into the respective mounting grooves.

(11) Preferably, in (4) or (6) above, the female terminal is configured to be stored in an insulating housing, the opening prevention member or the biasing member has a fitting portion to be fitted within a to-be-fitted portion provided in the housing, and the female terminal is positioned on the housing by fitting of the fitting portion within the to-be-fitted portion. This is because a mechanism for positioning the female terminal on the housing can also be configured through use of the opening prevention member or the biasing member, so that reduction in the number of components and size reduction can be accomplished.

(12) Preferably, in (1) above, the first flat plate fitting and the second flat plate fitting are configured by a metal flat plate having a strip shape in which the first other end portion and the second other end portion are coupled to each other with a coupling portion interposed therebetween, the first circumferential wall portion of the first flat plate fitting and the second circumferential wall portion of the second flat plate fitting are provided respectively in both end portions of the metal flat plate, the coupling portion of the metal flat plate is bent in a plate thickness direction to overlap the first other end portion of the first flat plate fitting and the second other end portion of the second flat plate fitting on each other to configure the wire connecting portion, and the first circumferential wall portion and the second circumferential wall portion provided in both the end portions are arranged in an opposed manner to each other with a gap formed therebetween to configure the cylindrical connecting portion, the first flat plate fitting has a first intermediate plate portion configured to couple the first circumferential wall portion and the first other end portion, the second flat plate fitting has a second intermediate plate portion configured to couple the second circumferential wall portion and the second other end portion, displacement of the first circumferential wall portion and the second circumferential wall portion to be spaced in a direction opposite to an opposed direction of the first circumferential wall portion and the second circumferential wall portion is allowed by elastic deformation of the first intermediate plate portion and the second intermediate plate portion, a biasing member configured to bias the first circumferential wall portion and the second circumferential wall portion in the opposed direction is mounted on the cylindrical connecting portion, the biasing member includes a ring member made of metal notched in a location in the circumferential direction, an inner circumferential surface of the ring member is pressed against and mounted on an outer circumferential surface of the cylindrical connecting portion, the cylindrical connecting portion is arranged to open toward a front side in a spacing direction from the wire connecting portion, and the first circumferential wall portion and the second circumferential wall portion each include a slit which extends through in a plate thickness direction to open toward the front side in the spacing direction and a plurality of divided wall portions which are spaced from each other in the circumferential direction with the slit interposed therebetween.

### Details of Embodiments of the Present Disclosure

Specific examples of the female terminal of the present disclosure will be described below with reference to the drawings. Note that the present disclosure is not limited to these exemplifications but is indicated by the scope of claims, and all changes which come within the meaning and scope of equivalency of the claims are intended to be embraced therein.

### First Embodiment

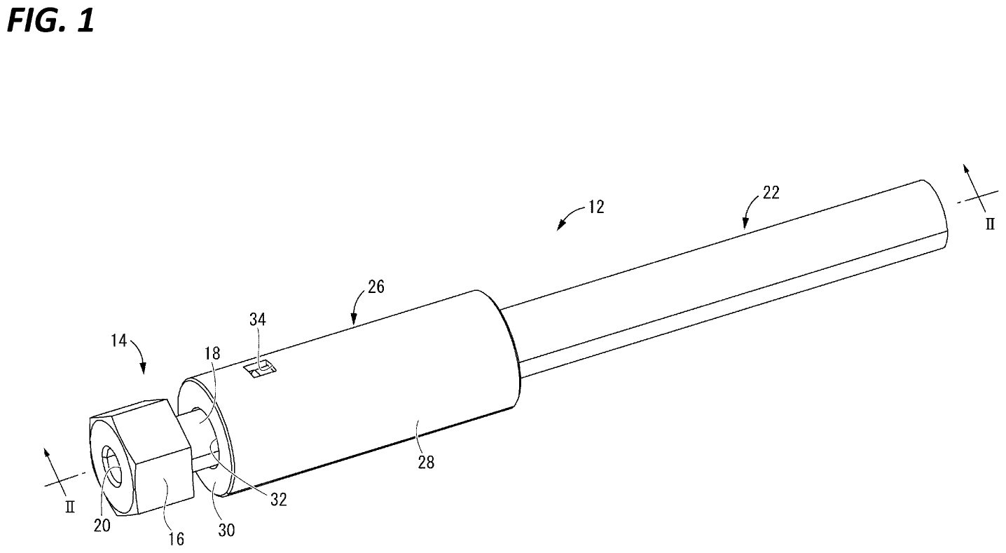

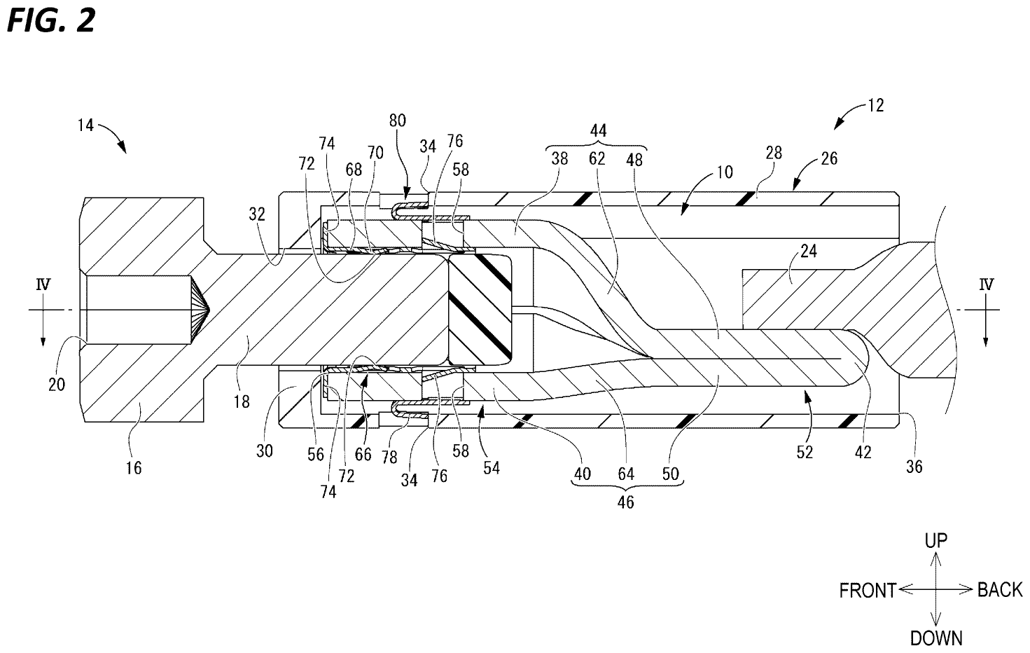

Hereinafter, a female terminal 10 of a first embodiment of the present disclosure will be described with reference to FIGS. 1 to 4. FIGS. 1 to 4 show a female connector 12 including the female terminal 10 of the present disclosure and a male terminal 14 to be conductively connected to the female terminal 10. The male terminal 14 is provided to protrude in an enclosure of an on-board device such as a high-voltage battery not shown and is conductively connected to the female connector 12 provided at a terminal of a covered wire 22 which will be described later connected to another on-board device such as an inverter, so that the on-board devices are electrically connected. Note that the female terminal 10 can be arranged in any orientation. In the following description, the vertical direction is the vertical direction in FIG. 2, the front-to-back direction is the horizontal direction in FIG. 2, and the horizontal direction is the direction orthogonal to the sheet of drawing in FIG. 2. For a plurality of identical members, only some members are denoted by reference numerals, and reference numerals of other members are omitted in some cases.

### Male Terminal 14

The male terminal 14 is configured by machining metal having a relatively low electrical resistance, such as copper, a copper alloy, aluminum, or an aluminum alloy, into a predetermined shape by cutting machining or press working. The male terminal 14 integrally includes a fixed portion 16 to be fixed to a device-side connecting portion provided in an enclosure of an on-board device such as a high-voltage battery not shown in a connected state and a columnar connecting portion 18 protruding from the fixed portion 16 to the outside of the enclosure. The fixed portion 16 is provided with a bolt tightening hole 20 in which a tightening bolt (illustration of which is omitted) for fixing to the device-side connecting portion is to be tightened.

### Female Connector 12

The female connector 12 includes the covered wire 22 connected to an on-board device not shown, the female terminal 10 to which a core 24 configured by metal such as copper or aluminum exposed at a terminal of the covered wire 22 is to be connected, and an insulating housing 26 that stores the female terminal 10. The housing 26 is an integrated injection molded product formed using synthetic resin or the like and including a main body portion 28 having a hollow cylindrical shape and a front cover portion 30 that covers a front-side opening of the main body portion 28. Note that the front cover portion 30 is provided with an insertion hole 32 through which the columnar connecting portion 18 of the male terminal 14 can be inserted, the insertion hole 32 extending through in the thickness direction. The main body portion 28 of the housing 26 is provided with a pair of to-be-fitted portions 34 in two locations spaced in a circumferential direction of the main body portion 28 and opposed in a radial direction, the pair of to-be-fitted portions 34 having a rectangular hole shape extending through in a plate thickness direction. A back-side opening 36 of the main body portion 28 of the housing 26 is open without being covered, and the female terminal 10 is stored in the housing 26 through the back-side opening 36. The female terminal 10 stored in the housing 26 is positioned on and incorporated into the housing 26 when a pair of fitting portions 78 of a ring member 80 which will be described later provided for the female terminal 10 are fitted with the pair of to-be-fitted portions 34, respectively (see FIG. 2).

### Female Terminal 10

The female terminal 10 is obtained by press-working a metal flat plate having a strip shape into a predetermined shape. The metal flat plate having a strip shape can be cut out from an elongated metal material having a low electrical resistance, such as copper, a copper alloy, aluminum, or an aluminum alloy, into a predetermined length dimension and width dimension. In the present embodiment, both end portions of the metal flat plate having a strip shape are deformed by press working to be curved into a semi-cylindrical shape protruding to the same side in the plate thickness direction, thereby forming a first circumferential wall portion 38 and a second circumferential wall portion 40. The first circumferential wall portion 38 and the second circumferential wall portion 40 are deformed to be curved with generally the same curvature and are provided in such an orientation that their axial direction is oriented in a longitudinal direction of the metal flat plate having a strip shape.

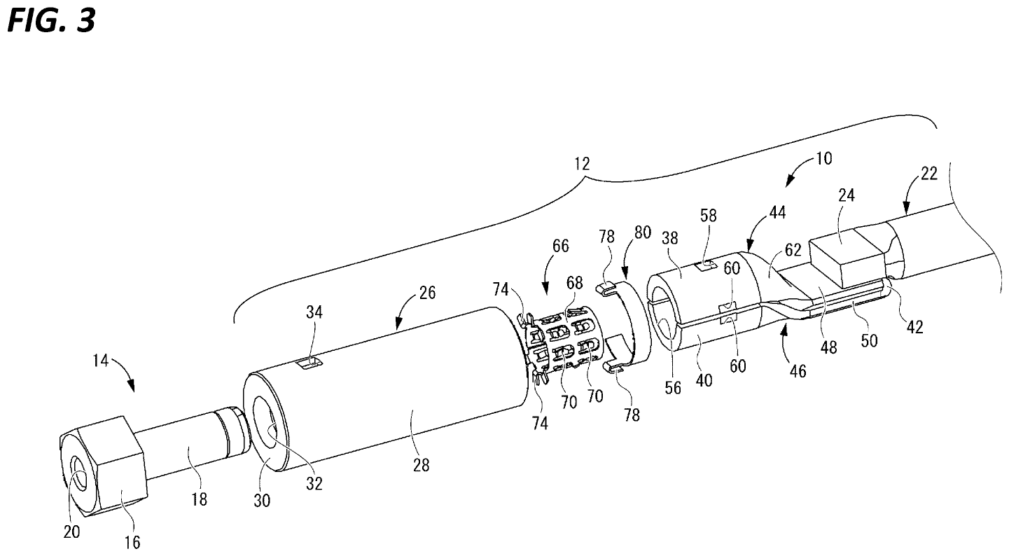

A coupling portion 42 is configured by a generally central portion in the longitudinal direction of the metal flat plate having a strip shape. A first flat plate fitting 44 is configured by a side where the first circumferential wall portion 38 is provided with the coupling portion 42 interposed therebetween, and a second flat plate fitting 46 is configured by a side where the second circumferential wall portion 40 is provided. In the first flat plate fitting 44, a first other end portion 48 which is the other end portion opposite to one end portion in which the first circumferential wall portion 38 is provided is continuous with the coupling portion 42 and spreads in a flat plate shape. In the second flat plate fitting 46, a second other end portion 50 which is the other end portion opposite to one end portion in which the second circumferential wall portion 40 is provided is continuous with the coupling portion 42 and spreads in a flat plate shape. Moreover, the coupling portion 42 of the metal flat plate is bent to protrude in the plate thickness direction which is the same as the side to which the first circumferential wall portion 38 and the second circumferential wall portion 40 protrude, so that the first other end portion 48 of the first flat plate fitting 44 and the second other end portion 50 of the second flat plate fitting 46 are overlapped on each other. A wire connecting portion 52 is configured by the first other end portion 48 and the second other end portion 50 thus overlapped on each other. As shown in FIG. 3, the core 24 of the covered wire 22 is overlapped on the wire connecting portion 52 and welded through ultrasonic welding or the like, so that the core 24 of the covered wire 22 is fixedly and electrically connected to the wire connecting portion 52. Note that the first other end portion 48 and the second other end portion 50 that configure the wire connecting portion 52 may have mutual opposed surfaces attached to each other when the core 24 is welded or may be arranged in proximity in an opposed manner at least partially with a gap formed therebetween.

The first circumferential wall portion 38 and the second circumferential wall portion 40 are arranged in an opposed manner with a gap formed therebetween in the state where the wire connecting portion 52 is configured by the first other end portion 48 and the second other end portion 50 overlapped on each other. Then, a cylindrical connecting portion 54 in which the columnar connecting portion 18 of the male terminal 14 is inserted and arranged to be connected is configured by the first circumferential wall portion 38 and the second circumferential wall portion 40 thus arranged in the opposed manner (see FIG. 3).

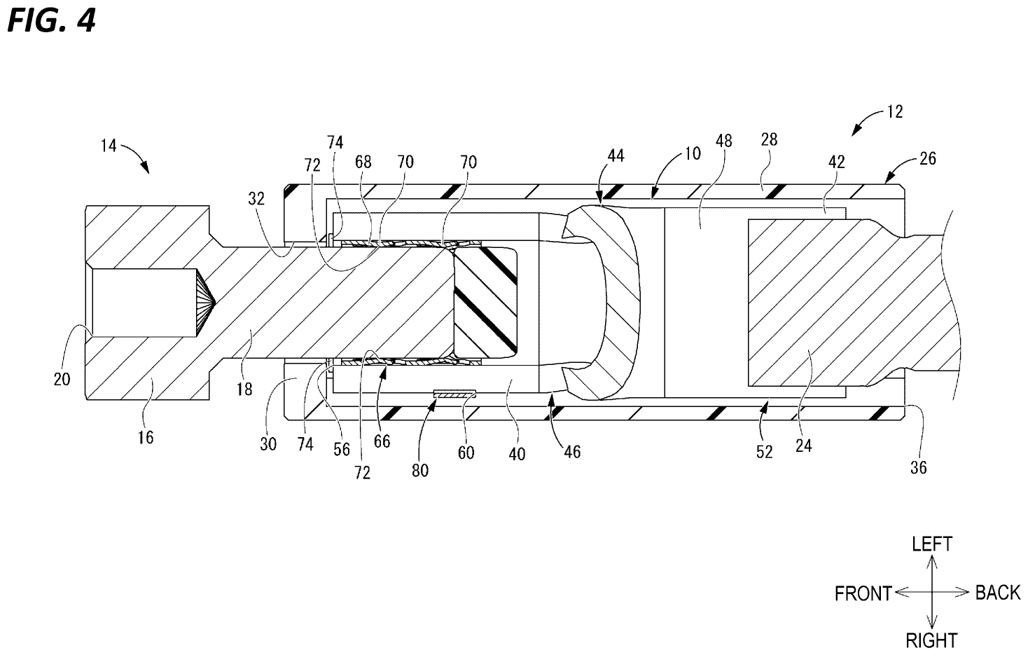

In the present embodiment, the cylindrical connecting portion 54 is arranged to open toward the front side in the spacing direction from the wire connecting portion 52 (see FIG. 3), and the columnar connecting portion 18 of the male terminal 14 is to be inserted into the cylindrical connecting portion 54 through the front-side opening 56 of the cylindrical connecting portion 54. Then, the first circumferential wall portion 38 and the second circumferential wall portion 40 that configure the cylindrical connecting portion 54 are provided with a pair of engagement holes 58, 58 each provided to extend in the plate thickness direction through a central portion in the circumferential direction by press die cutting. The pair of engagement holes 58, 58 are arranged in an opposed manner in the opposed direction of the first circumferential wall portion 38 and the second circumferential wall portion 40 and in the radial direction of the cylindrical connecting portion 54 (see FIG. 2). Moreover, mutually opposed circumferential end portions (circumferential end portions positioned on the right side in FIG. 3) of the first circumferential wall portion 38 and the second circumferential wall portion 40 are respectively provided with concaved fitting grooves 60, 60 that open in an outer circumferential surface. The fitting groove 60 in the first circumferential wall portion 38 and the fitting groove 60 in the second circumferential wall portion are arranged in an opposed manner with a gap formed therebetween in the circumferential direction and extend in the circumferential direction over a predetermined length. As shown in FIG. 4, the ring member 80 which will be described later is fitted into the fitting grooves 60, 60, so that the ring member 80 is positioned in the axial direction (the front-to-back direction in FIG. 4) of the cylindrical connecting portion 54.

As shown in FIG. 2, the first flat plate fitting 44 has a first intermediate plate portion 62 that couples the first circumferential wall portion 38 and the first other end portion 48, and the second flat plate fitting 46 has a second intermediate plate portion 64 that couples the second circumferential wall portion 40 and the second other end portion 50. The first intermediate plate portion 62 is curved in a generally arc shape along the curvature of the first circumferential wall portion 38 on the first circumferential wall portion 38 side but spreads in a generally flat plate shape on the first other end portion 48 side with the curvature decreasing toward the first other end portion 48. The second intermediate plate portion 64 also has a shape whose curvature changes generally similarly to the first intermediate plate portion 62 and extends between the second circumferential wall portion 40 and the second other end portion 50. In the first flat plate fitting 44, the first circumferential wall portion 38 is coupled to the first other end portion 48 in a cantilevered manner with the first intermediate plate portion 62 interposed therebetween. In the second flat plate fitting 46, the second circumferential wall portion 40 is coupled to the second other end portion 50 in the cantilevered manner with the second intermediate plate portion 64 interposed therebetween.

### Contact Member 66

The female terminal 10 further includes a contact member 66. The contact member 66 is formed by subjecting a metal material of copper, a copper alloy, aluminum, an aluminum alloy, or the like to press bending or the like. As shown in FIG. 3, the contact member 66 has a mounting cylindrical portion 68 which is thinner than the first circumferential wall portion 38 and the second circumferential wall portion 40 and which has a generally cylindrical shape, and a plurality of spring contact portions 70 provided in a plurality of locations spaced from each other in the circumferential direction and the axial direction of the mounting cylindrical portion 68. As shown in FIG. 2, each of the spring contact portions 70 is provided by cutting and raising a circumferential wall of the mounting cylindrical portion 68 to an inner circumferential side in a cantilevered manner. Each of the spring contact portions 70 has a contact 72 in an intermediate portion in the protruding direction, the contact 72 being bent to an inner side in the radial direction of the mounting cylindrical portion 68 so as to present a generally V-shaped cross-sectional shape. Furthermore, in one open end portion (on the front side in FIG. 3) of the mounting cylindrical portion 68 of the contact member 66, a plurality of abutting pieces 74 (six in the present embodiment) are provided in a plurality of locations spaced from each other in the circumferential direction so as to protrude to the outer circumferential side.

On the other open end portion side (the back side in FIG. 3) of the mounting cylindrical portion 68 of the contact member 66, a pair of engagement portions 76, 76 are also provided in two locations spaced from each other in the circumferential direction and opposed in the radial direction. Each of the engagement portions 76 is provided by cutting and raising the circumferential wall of the mounting cylindrical portion 68 to the outer circumferential side in a cantilevered manner and protrudes from the other open end portion side (the back side) toward the one open end portion side (the front side).

The contact member 66 having such a configuration is inserted into the inside through the front-side opening 56 of the cylindrical connecting portion 54 from the open end portion side (the back side in FIG. 3) where the abutting pieces 74 are not provided. When the abutting pieces 74 abut on the front-side opening 56 of the cylindrical connecting portion 54, an insertion end of the contact member 66 into the cylindrical connecting portion 54 is defined. As shown in FIG. 2, at an insertion end position of the contact member 66 into the cylindrical connecting portion 54, a protruding end portion of each of the engagement portions 76 engages with a front side end surface in an inner circumferential-side opening of each of the engagement holes 58 provided in the first circumferential wall portion 38 and the second circumferential wall portion 40. As described, the cylindrical connecting portion 54 of the contact member 66 is restricted from being displaced in the axial direction (the front-to-back direction in the drawing) by abutting of each of the abutting pieces 74 on the front-side opening 56 of the cylindrical connecting portion 54 and engagement of each of the engagement portions 76 with the front side end surface of each of the engagement holes 58, and the contact member 66 is positioned on the cylindrical connecting portion 54.

Furthermore, since an outer diameter dimension of the contact member 66 is made slightly larger than an inner diameter dimension of the cylindrical connecting portion 54, the outer circumferential surface of the mounting cylindrical portion 68 of the contact member 66 is pressed against the inner circumferential surfaces of the first circumferential wall portion 38 and the second circumferential wall portion 40 in the state where the contact member 66 is arranged on the inner circumferential side of the cylindrical connecting portion 54. When the columnar connecting portion 18 of the male terminal 14 is inserted through the front-side opening 56 of the cylindrical connecting portion 54, each of the spring contact portions 70 warps and is deformed to the outer circumferential side, which allows insertion of the columnar connecting portion 18 into the cylindrical connecting portion 54. Then, each of the spring contact portions 70 is biased to come into contact with the outer circumferential surface of the columnar connecting portion 18 by an elastic restoring force of each of the spring contact portions 70, so that the contact 72 of each of the spring contact portions 70 is pressed against the outer circumferential surface of the columnar connecting portion 18 (see FIG. 2).

### Ring Member 80 (Opening Prevention Member)

The female terminal 10 further includes the ring member 80 serving as an opening prevention member. The ring member 80 is configured using a C-ring made of metal notched in a location in the circumferential direction. The ring member 80 can be fitted laterally into the outer circumferential surface of the cylindrical connecting portion 54 through the notched portion on the circumference. The ring member 80 has an inner diameter dimension slightly smaller than the outer diameter dimension of the cylindrical connecting portion 54. Therefore, when the first circumferential wall portion 38 and the second circumferential wall portion 40 that configure the cylindrical connecting portion 54 are going to be displaced in the direction opposite to the opposed direction, the ring member 80 fitted over the cylindrical connecting portion 54 applies a force that restricts displacement in the opposite direction because of the elastic restoring force of the ring member 80. Accordingly, the ring member 80 functions as the opening prevention member that restricts the first circumferential wall portion 38 and the second circumferential wall portion 40 from being displaced in the direction opposite to the opposed direction.

Note that the ring member 80 fitted laterally over the outer circumferential surface of the cylindrical connecting portion 54 is fitted into the fitting grooves 60 respectively provided in the outer circumferential surfaces of the first circumferential wall portion 38 and the second circumferential wall portion 40 of the cylindrical connecting portion 54 (see FIG. 4). Accordingly, displacement of the ring member 80 in the axial direction (the front-to-back direction in the drawing) on the cylindrical connecting portion 54 is restricted by abutment of the ring member 80 on sidewalls of the fitting groove 60, and the ring member 80 is positioned on the cylindrical connecting portion 54. The ring member 80 is arranged to cover the outer circumferential-side openings of the pair of engagement holes 58, 58 in the state where the ring member 80 is positioned on the cylindrical connecting portion 54 as described (see FIG. 2).

The ring member 80 further has the pair of fitting portions 78, 78 arranged in an opposed manner in the radial direction in a plurality of locations (two locations in the present embodiment) spaced from each other in the circumferential direction. Each of the fitting portions 78 has a shape folded into a generally U-shape in side view from the one end portion (the front end portion in FIG. 2) in the axial direction of the ring member 80 toward the other end portion (the back end portion in FIG. 2) in the axial direction. The pair of fitting portions 78, 78 of the ring member 80 are fitted into the pair of to-be-fitted portions 34, 34 provided in the housing 26 when the female terminal 10 is stored in the housing 26 (see FIG. 2). Falling out of the female terminal 10 from the housing 26 is thereby avoided, and the female terminal 10 is positioned on the housing 26.

Subsequently, action and effect of the female terminal 10 according to the present embodiment will be described. According to the female terminal 10 of the present embodiment, the first circumferential wall portion 38 and the second circumferential wall portion 40, each of which is provided by deforming the one end portion of a metal flat plate having a strip shape to be curved into a semi-cylindrical shape, are arranged in the opposed manner to each other with a gap formed therebetween, thereby configuring the cylindrical connecting portion 54. Therefore, there is no need to bend the metal flat plate into a complete 360-degree cylindrical shape as in the conventional structure described in Japanese Patent Laid-open Publication No. 2013-187171. The cylindrical connecting portion can be deformed to be curved into a semi-cylindrical shape even in a case where the cylindrical connecting portion is increased in plate thickness in order to deal with an increase in current, so that the female terminal 10 can be easily manufactured. The first other end portion 48 of the first flat plate fitting 44 with the first circumferential wall portion 38 provided in the one end portion and the second other end portion 50 of the second flat plate fitting 46 with the second circumferential wall portion 40 provided in the one end portion are overlapped on each other to configure the wire connecting portion 52. Therefore, the first circumferential wall portion 38 and the second circumferential wall portion 40 that configure the cylindrical connecting portion are as a whole directly continuous with the wire connecting portion 52 with the first intermediate plate portion 62 and the second intermediate plate portion 64 interposed therebetween, so that the conduction resistance of the female terminal 10 can be reduced and the heat radiation performance can be improved as compared with the case where only a partial region of the cylindrical connecting portion is connected to the wire connecting portion as in the conventional structure described in Japanese Patent Laid-open Publication No. 2013-187171.

Particularly in the present embodiment, the first circumferential wall portion 38 and the second circumferential wall portion 40 are provided by press working in both the end portions of the metal flat plate having a strip shape, and the coupling portion 42 provided in the central portion of the metal flat plate is bent in the plate thickness direction, thereby configuring the female terminal 10. In other words, the cylindrical connecting portion 54 and the wire connecting portion 52 can be easily manufactured merely by folding the metal flat plate in half in the length direction. Productivity and handling performance can thereby be improved further.

Moreover, the contact member 66 is fitted within the cylindrical connecting portion 54 on the inner circumferential side, and the contact member 66 has the plurality of spring contact portions 70 to bias and to be brought into contact with the outer circumferential surface of the columnar connecting portion 18 of the male terminal 14 inserted into the cylindrical connecting portion 54. This facilitates controlling a contact pressure of the cylindrical connecting portion 54 against the male terminal 14. In particular, the contact member 66 is formed using a metal plate material thinner than the first circumferential wall portion 38 and the second circumferential wall portion 40. Therefore, a decrease in contact pressure of the cylindrical connecting portion 54 is easy to achieve, and an insertion force when the female and male terminals are fitted with each other can be advantageously reduced. Moreover, the contact resistance can also be reduced by providing the plurality of spring contact portions 70 to increase contacts. Furthermore, deformation or the like of the contact member 66 is also avoided advantageously as the ring member 80 is mounted on the cylindrical connecting portion 54 to restrict the first circumferential wall portion 38 and the second circumferential wall portion 40 from being displaced in the direction opposite to the opposed direction.

Furthermore, the ring member 80 is arranged to cover the outer circumferential-side openings of the plurality of engagement holes 58, and the plurality of engagement portions 76 provided for the contact member 66 are respectively engaged with the inner circumferential-side openings of the plurality of engagement holes 58, so that the contact member 66 is positioned on the cylindrical connecting portion 54.

The contact member 66 can thereby be positioned on the cylindrical connecting portion 54 using the plurality of engagement holes 58 provided in the first circumferential wall portion 38 and the second circumferential wall portion 40. The outer circumferential-side openings of the plurality of engagement holes 58 can then be covered by the ring member 80. As a result, entry of a foreign matter into the cylindrical connecting portion 54 can be reduced or avoided with the contact member 66 stably positioned on the cylindrical connecting portion 54, which can advantageously achieve stability of conduction of the female terminal 10.

### Second Embodiment

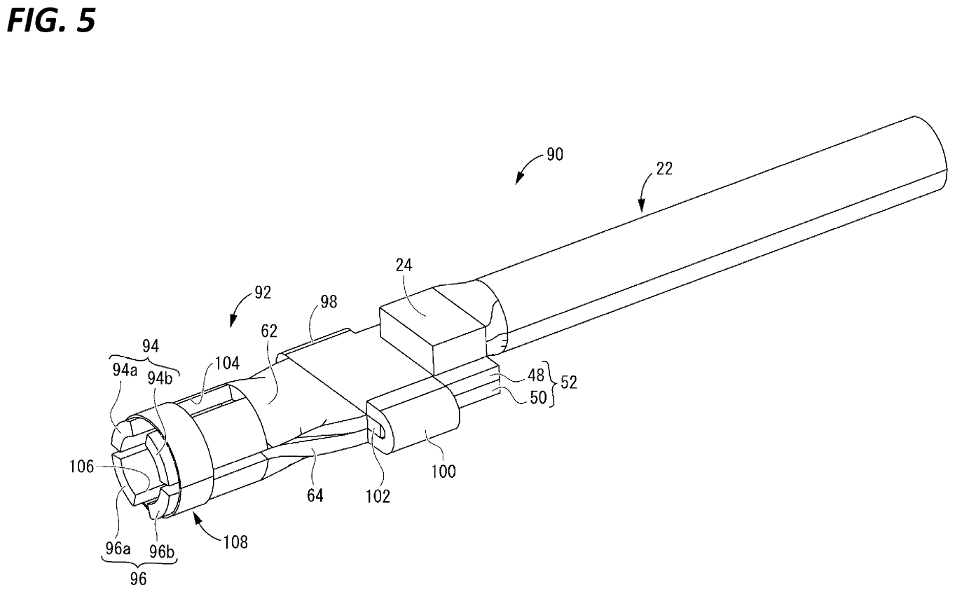

Next, a female terminal 90 according to a second embodiment of the present disclosure will be described with reference to FIG. 5. The female terminal 90 of the second embodiment basically has a structure similar to that of the female terminal 10 of the first embodiment but is different from the first embodiment in that, for example, the contact member 66 is not included and a contact with the columnar connecting portion 18 of the male terminal 14 is configured by a first circumferential wall portion 94 and a second circumferential wall portion 96 that configure a cylindrical connecting portion 92. In the following description, differences from the first embodiment will be described, and members and portions substantially identical to those of the first embodiment are denoted in the drawing by reference characters identical to those of the first embodiment and detailed description will thus be omitted.

The female terminal 90 is the same as the female terminal 10 of the first embodiment in that the first flat plate fitting 44 and the second flat plate fitting 46 are included but is different from the first embodiment in that the first flat plate fitting 44 and the second flat plate fitting 46 are integrated with a coupling portion 98 (on the left side in FIG. 5) interposed therebetween, the coupling portion 98 coupling respective lateral edges of the first other end portion 48 and the second other end portion 50 to each other. In other words, in the female terminal 90, the first flat plate fitting 44 and the second flat plate fitting 46 arranged in parallel configure the wire connecting portion 52 with the first other end portion 48 of the first flat plate fitting 44 and the second other end portion 50 of the second flat plate fitting 46 overlapped on each other by bending the coupling portion 98 in the plate thickness direction. A swaging piece 100 is provided on a lateral edge (on the right side in FIG. 5) of the second other end portion 50 on the opposite side of the coupling portion 98 and is swaged on a swaging protrusion 102 provided on a lateral edge of the first other end portion 48 on the opposite side (the right side in FIG. 5) of the coupling portion 98. The first flat plate fitting 44 and the second flat plate fitting 46 are thereby prevented from opening in the direction opposite to the opposed direction.

The second embodiment is the same as the first embodiment in that the first circumferential wall portion 94 is coupled to the first other end portion 48 with the first intermediate plate portion 62 interposed therebetween, and the second circumferential wall portion 96 is coupled to the second other end portion 50 with the second intermediate plate portion 64 interposed therebetween. Therefore, a spacing displacement of the first circumferential wall portion 94 and the second circumferential wall portion 96 in the direction opposite to the opposed direction is allowed by elastic deformation of the first intermediate plate portion 62 and the second intermediate plate portion 64.

The cylindrical connecting portion 92 configured by the first circumferential wall portion 94 and the second circumferential wall portion 96 is arranged to open toward the front side (the front side in FIG. 5) in the direction spaced from the wire connecting portion 52. The first circumferential wall portion 94 has a slit 104 which extends through in the plate thickness direction and opens toward the front side in the spacing direction from the wire connecting portion 52, and a plurality of divided wall portions 94a, 94b which are spaced from each other in the circumferential direction with the slit 104 interposed therebetween. The second circumferential wall portion 96 has a slit 106 which extends through in the plate thickness direction and opens toward the front side in the spacing direction from the wire connecting portion 52, and a plurality of divided wall portions 96a, 96b which are spaced from each other in the circumferential direction with the slit 106 interposed therebetween. The divided wall portions 94a, 94b, 96a, 96b all protrude from the first and second intermediate plate portions 62, 64 toward the front side in a cantilevered manner. Inner circumferential surfaces of the divided wall portions 94a, 94b, 96a, 96b are surfaces to be brought into contact with the outer circumferential surface of the columnar connecting portion 18 of the male terminal 14, and contacts of the female terminal 90 with the columnar connecting portion 18 are provided on the inner circumferential surfaces of the divided wall portions 94a, 94b, 96a, 96b.

A ring member 108 that configures a biasing member that biases the first circumferential wall portion 94 and the second circumferential wall portion 96 in the opposed direction is mounted on an outer circumferential surface of the cylindrical connecting portion 92 on the protruding end side of the divided wall portions 94a, 94b, 96a, 96b. The ring member 108 is configured by a C-ring made of metal notched in a location in the circumferential direction. The ring member 108 can be fitted laterally over the outer circumferential surface of the cylindrical connecting portion 92 through the notched portion on the circumference. The ring member 108 has an inner diameter dimension slightly smaller than an outer diameter dimension of the cylindrical connecting portion 92. Therefore, the ring member 108 fitted over the cylindrical connecting portion 92 applies a biasing force that displaces the divided wall portions 94a, 94b, 96a, 96b that configure the cylindrical connecting portion 92 in the opposed direction which is a direction approaching each other. In other words, when the columnar connecting portion 18 of the male terminal 14 is press-fitted into the cylindrical connecting portion 92, the divided wall portions 94a, 94b, 96a, 96b are displaced to the outer side in the radial direction of the cylindrical connecting portion 92 which is the direction opposite to the opposed direction against the biasing force of the ring member 108. The displacement of the divided wall portions 94a, 94b, 96a, 96b to the outer side in the radial direction is also allowed by elastic deformation of the first and second intermediate plate portions 62, 64 in the direction opposite to the opposed direction. As a result, the divided wall portions 94a, 94b of the first circumferential wall portion 94 and the divided wall portions 96a, 96b of the second circumferential wall portion 96 are pressed against the outer circumferential surface of the columnar connecting portion 18 of the male terminal 14 because of an elastic restoring force of the first and second intermediate plate portions 62, 64. In addition, the divided wall portions 94a, 94b of the first circumferential wall portion 94 and the divided wall portions 96a, 96b of the second circumferential wall portion 96 are also pressed against the outer circumferential surface of the columnar connecting portion 18 of the male terminal 14 because of an elastic restoring force of the ring member 108.

In the present embodiment, stability of conduction of the female terminal 90 can be improved advantageously since the contact pressure of the divided wall portions 94a, 94b of the first circumferential wall portion 94 and the divided wall portions 96a, 96b of the second circumferential wall portion 96 against the columnar connecting portion 18 of the male terminal 14 is applied using the ring member 108. Moreover, the inner circumferential surface of the ring member 108 is pressed against and mounted on the outer circumferential surface of the cylindrical connecting portion 92. Therefore, the biasing force of the ring member 108 can be exerted uniformly over a wide area of the cylindrical connecting portion 92, and application of the contact pressure to the cylindrical connecting portion 92 can be achieved stably with a simple structure.

In addition, the first circumferential wall portion 94 and the second circumferential wall portion 96 are divided into the plurality of divided wall portions 94a, 94b, 96a, 96b which are respectively spaced from each other in the circumferential direction, and each of the divided wall portions 94a, 94b, 96a, 96b is held in a cantilevered manner such that an end on the front side in the spacing direction is a free end because of the slits 104, 106. Therefore, a following capability of the cylindrical connecting portion 92 with the displacement in the radial direction of the columnar connecting portion 18 of the male terminal 14 can be improved. Moreover, a biasing member can easily be configured using the ring member 108, and the following capability of the cylindrical connecting portion 92 with the male terminal 14 and improvement in the contact pressure can be achieved together advantageously.

### Third Embodiment

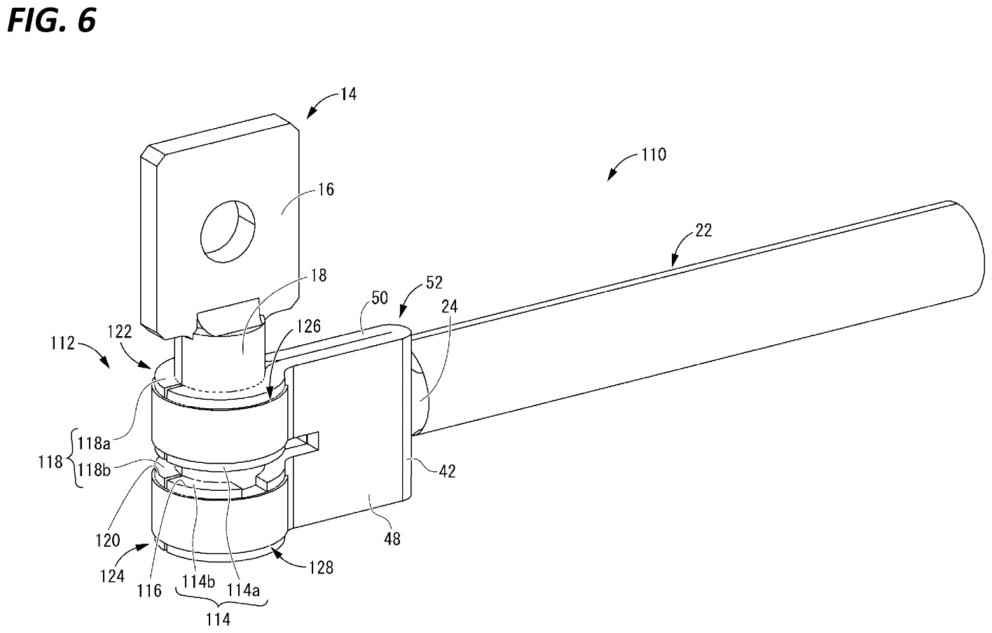

Subsequently, a female terminal 110 according to a third embodiment of the present disclosure will be described with reference to FIG. 6. The female terminal 110 of the third embodiment has a structure basically similar to that of the female terminal 10 of the first embodiment but is different from the first embodiment in that, for example, the contact member 66 is not included and a cylindrical connecting portion 112 is arranged to open on both sides of the cylindrical connecting portion 112 in the axial direction which is the direction orthogonal to the spacing direction from the wire connecting portion 52. In the following description, differences from the first embodiment will be described, and members and portions substantially identical to those of the first embodiment are denoted in the drawing by reference characters identical to those of the first embodiment and detailed description will thus be omitted.

As shown in FIG. 6, the cylindrical connecting portion 112 of the female terminal 110 is arranged to open on both the sides of the cylindrical connecting portion 112 in the axial direction which is the direction orthogonal to the spacing direction from the wire connecting portion 52. In other words, the cylindrical connecting portion 112 is arranged to open in the vertical direction. The first circumferential wall portion 114 has a slit 116 extending in a plate thickness direction through an intermediate portion in the axial direction, and has two divided wall portions 114a, 114b spaced from each other in the axial direction with the slit 116 interposed therebetween. The second circumferential wall portion 118 has a slit 120 extending in the plate thickness direction through the intermediate portion in the axial direction, and has two divided wall portions 118a, 118b spaced from each other in the axial direction with the slit 120 interposed therebetween. The divided wall portion 114a and the divided wall portion 118a are arranged in an opposed manner to each other to configure a divided cylindrical portion 122. The divided wall portion 114b and the divided wall portion 118b are arranged in an opposed manner to each other to configure a divided cylindrical portion 124. The divided cylindrical portion 122 and the divided cylindrical portion 124 are spaced from each other in the axial direction with the slits 116, 120 interposed therebetween.

A biasing member 126 configured using a C-ring made of metal notched in a location in the circumferential direction is mounted on an outer circumferential surface of the divided cylindrical portion 122. The divided wall portion 114a on the first circumferential wall portion 114 side and the divided wall portion 118a on the second circumferential wall portion 118 side are biased in the opposed direction by this biasing member 126. When the columnar connecting portion 18 of the male terminal 14 is inserted, a contact pressure for pressing the divided cylindrical portion 122 against a surface of the columnar connecting portion 18 can thereby be applied. Similarly, a biasing member 128 configured by a C-ring made of metal notched in a location in the circumferential direction is mounted on an outer circumferential surface of the divided cylindrical portion 124. The divided wall portion 114b on the first circumferential wall portion 114 side and the divided wall portion 118b on the second circumferential wall portion 118 side are biased in the opposed direction by this biasing member 128. When the columnar connecting portion 18 of the male terminal 14 is inserted, a contact pressure for pressing the divided cylindrical portion 124 against the surface of the columnar connecting portion 18 can thereby be applied.

In the female terminal 110 having such a configuration, the first circumferential wall portion 114 and the second circumferential wall portion 118 are divided respectively into a plurality of divided wall portions 114a, 114b, 118a, 118b spaced from each other in the axial direction of the cylindrical connecting portion 112, and the plurality of divided cylindrical portions 122 and 124 arranged to be spaced in the axial direction are thereby provided. Therefore, in a case where the columnar connecting portion 18 of the male terminal 14 inserted in the cylindrical connecting portion 112 is inclined in the axial direction, an excellent following capability with the displacement of the columnar connecting portion 18 can be exercised by the divided cylindrical portions 122, 124. Moreover, the separate biasing members 126 and 128 are respectively mounted on the divided cylindrical portion 122 and the divided cylindrical portion 124. A contact pressure against the male terminal 14 can thereby be applied individually to each of the divided cylindrical portions 122 and 124. Therefore, improvement in the following capability with the displacement of the columnar connecting portion 18 of the male terminal 14 and improvement in the contact pressure of each of the divided cylindrical portions 122 and 124 against the columnar connecting portion 18 can be accomplished together by the divided cylindrical portions 122 and 124.

### Modifications

The first to third embodiments have been described in detail above as specific examples of the present disclosure. However, the present disclosure is not limited to this specific description. Modifications, alterations, and the like within the range that the object of the present disclosure can be accomplished are embraced in the present disclosure. For example, modifications of the embodiments as will be described below are also embraced in the technical scope of the present disclosure.

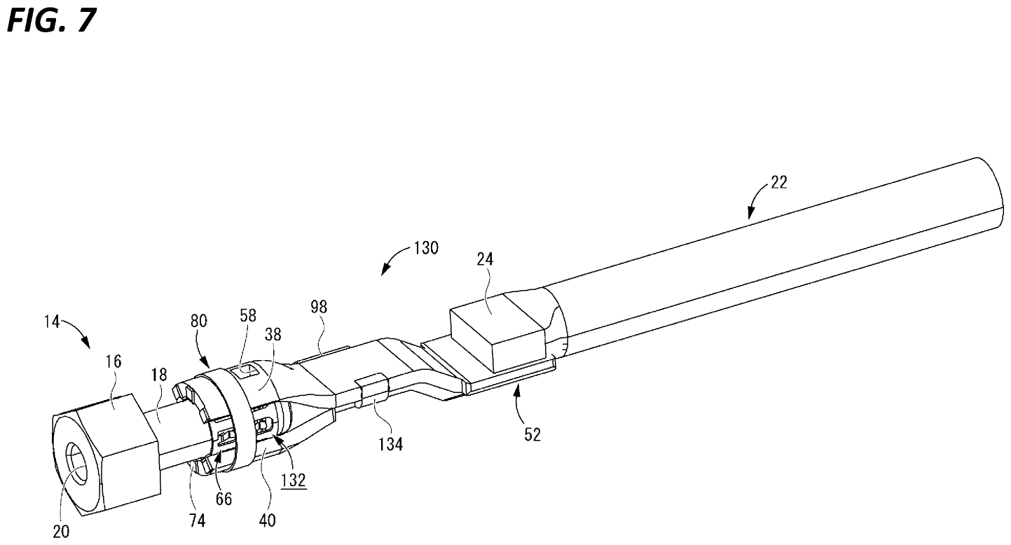

(1) In the female terminal 10 of the first embodiment, the first circumferential wall portion 38 and the second circumferential wall portion 40 are provided to be curved into a generally semi-cylindrical shape, but they are not necessarily limited to the semi-cylindrical shape. As in a female terminal 130 shown in FIG. 7, for example, the first circumferential wall portion 38 and the second circumferential wall portion 40 may be formed into an arc shape extending with a circumferential length less than the semi-cylindrical shape to form a gap 132 in the circumferential direction between the first circumferential wall portion 38 and the second circumferential wall portion 40. Alternatively, the coupling portion 98 that couples lateral edges of the first other end portion 48 and the second other end portion 50 may be provided, a swaging portion 134 may be provided on lateral edges on the opposite side as in the second embodiment, and the first other end portion 48 and the second other end portion 50 may be folded and overlapped on the lateral edge side to be firmly coupled with the swaging portion 134.

(2) In the first embodiment, the contact member 66 is fitted within the cylindrical connecting portion 54 but does not necessarily need to be included, and contacts may be configured directly by the inner circumferential surfaces of the first circumferential wall portion 94, 114 and the second circumferential wall portion 96, 118 as in the second or third embodiment.

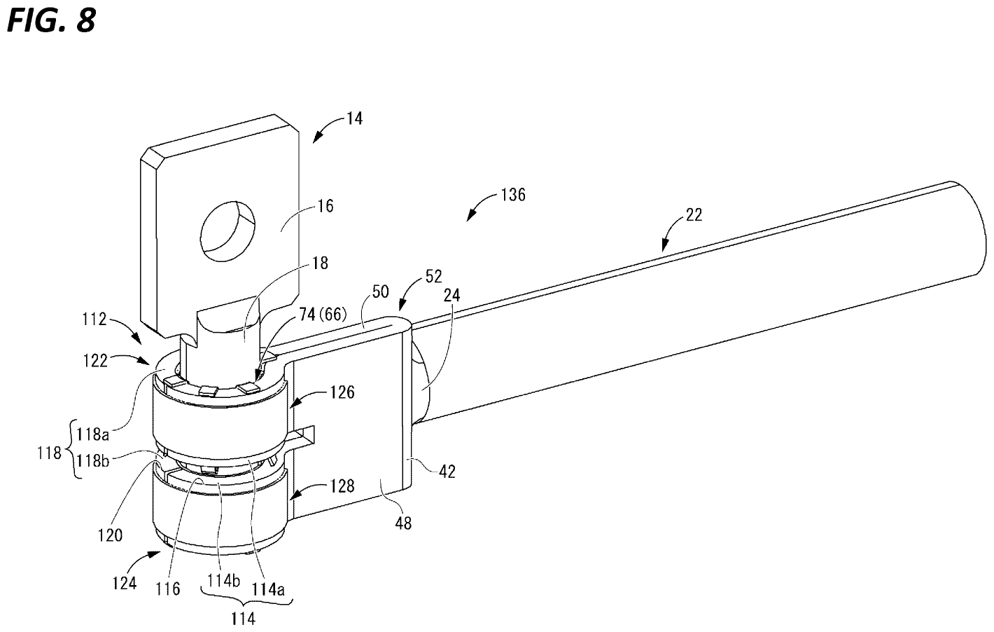

(3) To the contrary, the contact member 66 is not used in the female terminal 110 shown in FIG. 6, however, as in a female terminal 136 shown in FIG. 8, separate contact members 66 may be fitted within and held by the divided cylindrical portions 122 and 124 in the female terminal 136 of this type.

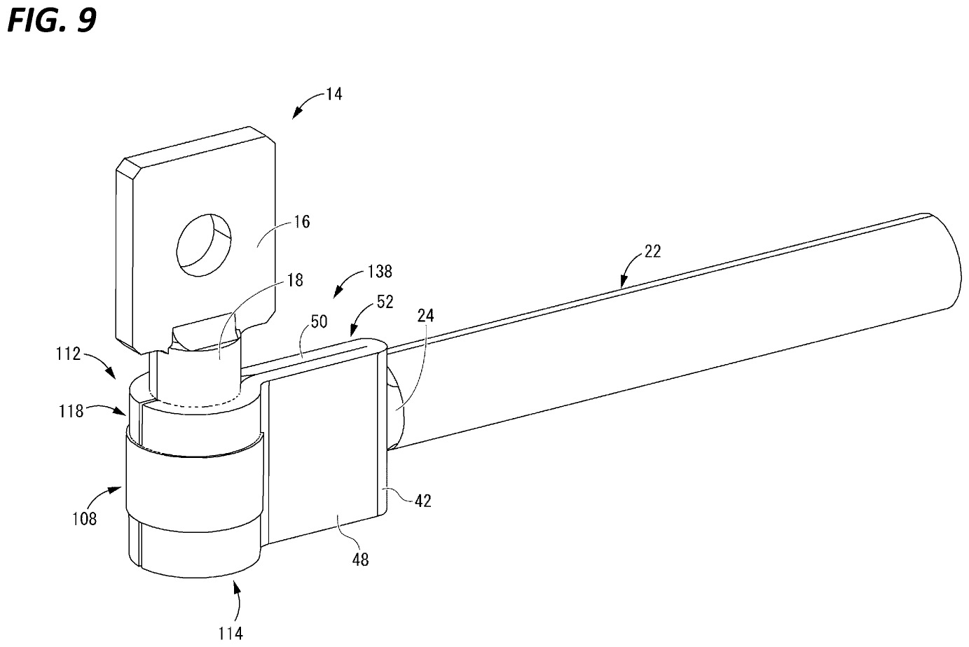

(4) Although the female terminal 110 of the third embodiment is of the type that the cylindrical connecting portion 112 is arranged to open on both the sides in the axial direction, the cylindrical connecting portion 112 does not necessarily need to be divided into the plurality of divided cylindrical portions 122 and 124 in the axial direction. As in a female terminal 138 shown in FIG. 9, the cylindrical connecting portion 112 may be configured by the first circumferential wall portion 114 and the second circumferential wall portion 118 extending continuously in the axial direction. In this case, the single ring member 108 may be fitted over the cylindrical connecting portion 112 to configure a biasing member.

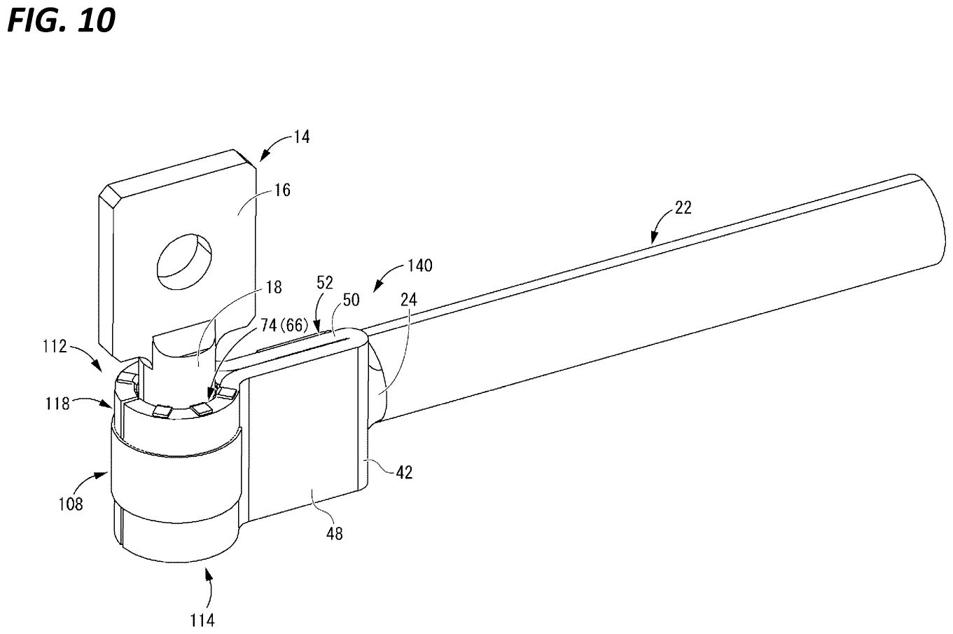

(5) Moreover, even in a case where the cylindrical connecting portion 112 is configured by the first circumferential wall portion 114 and the second circumferential wall portion 118 extending continuously in the axial direction as in a female terminal 140 shown in FIG. 10, contacts can be increased easily by fitting the contact member 66 within the cylindrical connecting portion 112.

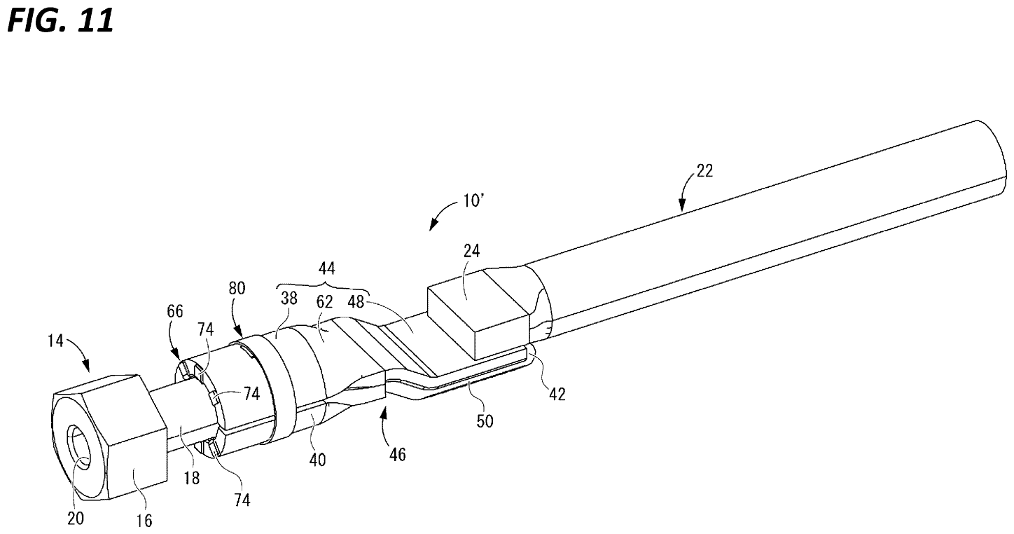

(6) In the female terminal 10 of the first embodiment, the spring characteristic of the ring member 80 is set such that the ring member 80 functions as an opening prevention member, however, this is not a limitation. For example, in a female terminal 10′ shown in FIG. 11, the spring characteristic of the ring member 80 may be set at such a spring characteristic that a biasing force can be applied to the first circumferential wall portion 38 and the second circumferential wall portion 40 in a direction approaching the opposed direction. The fitting portions 78 provided for the ring member 80 do not necessarily need to be provided.

(7) The female terminal according to the present disclosure may not be provided with members such as a ring member as an opening prevention member, a ring member as a biasing member, and a contact member. In other words, when the columnar connecting portion of the male terminal is inserted into the cylindrical connecting portion of the female terminal, the first circumferential wall portion and the second circumferential wall portion may be elastically deformed by the columnar connecting portion in the direction to be spaced from each other (to the outer side in the radial direction), and the columnar connecting portion may be supported on the cylindrical connecting portion by an elastic restoring force in the direction that the first circumferential wall portion and the second circumferential wall portion approach each other (to the inner side in the radial direction).

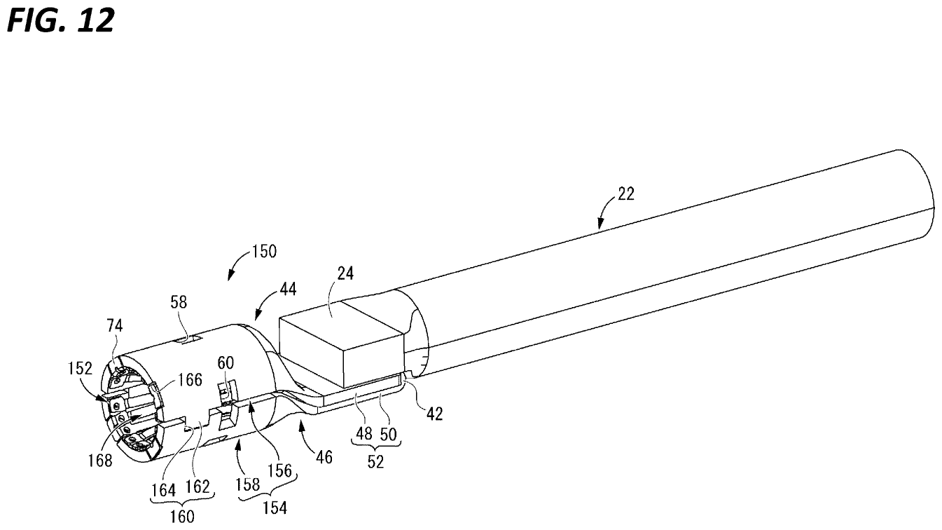

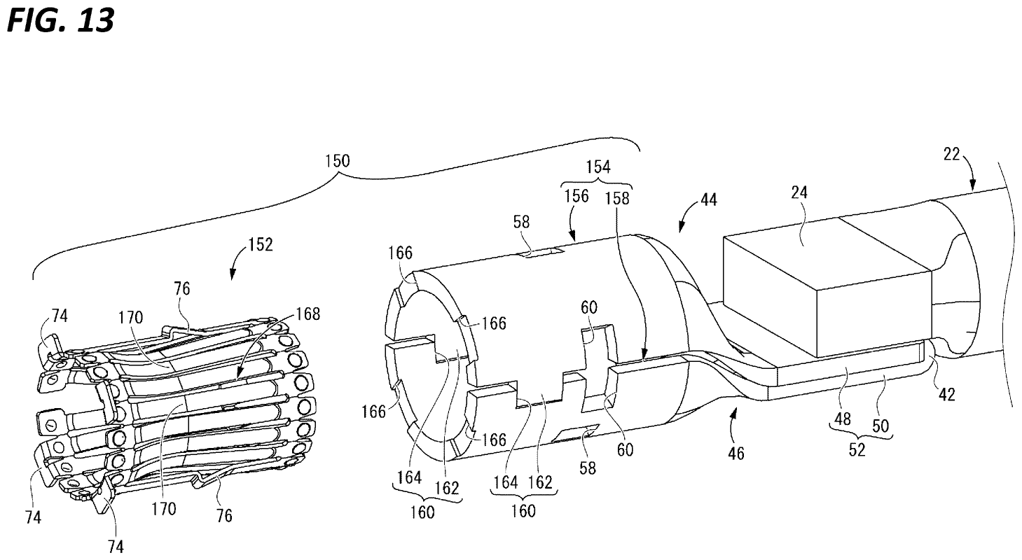

Alternatively, the female terminal according to the present disclosure may be provided only with a contact member 152 without being provided with a separate opening prevention member or biasing member as in a female terminal 150 shown in FIGS. 12 and 13. In an aspect shown in FIGS. 12 and 13, the cylindrical connecting portion 154 has a shape generally similar to the first embodiment. The first circumferential wall portion 156 and the second circumferential wall portion 158, each being curved into a generally semi-cylindrical shape, are arranged in an opposed manner with a narrow gap, thereby configuring the cylindrical connecting portion 154.

Note that in the aspect shown in FIGS. 12 and 13, mutually-fitted swaging portions 160 are provided in end surfaces in the circumferential direction where the first circumferential wall portion 156 and the second circumferential wall portion 158 are opposed to each other. Specifically, fitting protrusions 162, 162 protruding to the second circumferential wall portion 158 side are provided on both the end surfaces in the circumferential direction of the first circumferential wall portion 156, and fitting recesses 164, 164 which are open on the first circumferential wall portion 156 side are provided in both the end surfaces in the circumferential direction of the second circumferential wall portion 158. A widthwise dimension (a dimension in the front-to-back direction) of each of the fitting protrusions 162 is generally equal to or slightly larger than a widthwise dimension (a dimension in the front-to-back direction) of each of the fitting recesses 164. Accordingly, when a metal flat plate having a strip shape is subjected to press working or the like to configure the cylindrical connecting portion 154, each of the fitting protrusions 162 is fitted into each of the fitting recesses 164 in a generally press-fit state, so that the first circumferential wall portion 156 and the second circumferential wall portion 158 are prevented from being displaced in the direction to be spaced from each other when the male terminal 14 is inserted into the female terminal 150. In other words, an opening prevention member provided integrally for the first circumferential wall portion 156 and the second circumferential wall portion 158 may be configured by each of the fitting protrusions 162 and each of the fitting recesses 164.

Moreover, in the aspect shown in FIGS. 12 and 13, storage recesses 166 in which the respective abutting pieces 74 of the contact member 152 are to be stored are provided in a front end surface of the cylindrical connecting portion 154, that is, a front end surface of each of the first circumferential wall portion 156 and the second circumferential wall portion 158. The storage recesses 166 are provided at circumferential positions corresponding to the respective abutting pieces 74, and the plurality of respective storage recesses 166 are provided to be spaced from each other in the circumferential direction. Furthermore, in the aspect shown in FIGS. 12 and 13, the respective fitting grooves 60 provided in the circumferential end portions of the first circumferential wall portion 156 and the second circumferential wall portion 158 opposed to each other are provided respectively to extend through in the thickness direction of the first circumferential wall portion 156 and the second circumferential wall portion 158 (the radial direction of the cylindrical connecting portion 154).

The contact member 152 in the aspect shown in FIGS. 12 and 13 also has a basic structure similar to that of the contact member 66 of the first embodiment and includes a mounting cylindrical portion 168 having a generally cylindrical shape and a plurality of spring contact portions 170 provided in the mounting cylindrical portion 168 to be spaced from each other in the circumferential direction. The respective spring contact portions 170 have portions protruding to an inner circumferential side from a circumferential wall of the mounting cylindrical portion 168. The respective contacts 72 with the male terminal 14 are configured by these portions protruding to the inner circumferential side. In other words, when the male terminal 14 is inserted into the female terminal 150, the respective contacts 72 are pressed against the outer circumferential surface of the columnar connecting portion 18 of the male terminal 14, so that the plurality of spring contact portions 170 bias and come into contact with the outer circumferential surface of the columnar connecting portion 18.

The female terminal 150 having the above structure may also exert effects similar to the effects of the female terminal 10 in the first embodiment. In particular, the first embodiment adopts the separate ring member 80 as an opening prevention member that prevents the first circumferential wall portion 38 and the second circumferential wall portion 40 from being deformed to open, whereas in the aspect shown in FIGS. 12 and 13, the first circumferential wall portion 156 and the second circumferential wall portion 158 may be prevented from being deformed to open by the swaging portions 160. The number of components can thereby be reduced. The fitting protrusions and the fitting recesses may be provided oppositely. The fitting recesses may be provided in the first circumferential wall portion, and the fitting protrusions may be provided in the second circumferential wall portion.

Note that in the female terminal according to the present disclosure, the structure of the contact member is not limited, and any conventionally-known contact member can be adopted. In the aspect shown in FIGS. 12 and 13, for example, the contact member 66 having the same structure as in the first embodiment may be adopted.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A female terminal comprising:
a cylindrical connecting portion to be conductively connected to a columnar connecting portion of a male terminal; and
a wire connecting portion to which a core of a wire is to be connected, wherein
the cylindrical connecting portion has a first circumferential wall portion provided by deforming one end portion of a first flat plate fitting having a strip shape to be curved into an arc shape and a second circumferential wall portion provided by deforming one end portion of a second flat plate fitting having a strip shape into an arc shape,
the wire connecting portion is configured by overlapping a first other end portion which is the other end portion of the first flat plate fitting and a second other end portion which is the other end portion of the second flat plate fitting, and
the cylindrical connecting portion is configured with the first circumferential wall portion and the second circumferential wall portion arranged in an opposed manner with a gap formed therebetween by overlapping of the first other end portion of the first flat plate fitting and the second other end portion of the second flat plate fitting on each other.

2. The female terminal according to claim 1, wherein
the first flat plate fitting and the second flat plate fitting are configured by a metal flat plate having a strip shape in which the first other end portion and the second other end portion are coupled to each other with a coupling portion interposed therebetween,
the first circumferential wall portion of the first flat plate fitting and the second circumferential wall portion of the second flat plate fitting are provided respectively in both end portions of the metal flat plate, and
the coupling portion of the metal flat plate is bent in a plate thickness direction to overlap the first other end portion of the first flat plate fitting and the second other end portion of the second flat plate fitting on each other to configure the wire connecting portion, and the first circumferential wall portion and the second circumferential wall portion provided in both the end portions are arranged in an opposed manner to each other with a gap formed therebetween to configure the cylindrical connecting portion.

3. The female terminal according to claim 1, comprising
a cylindrical contact member arranged on an inner circumferential side of the cylindrical connecting portion, wherein
the contact member has a plurality of spring contact portions configured to bias and come into contact with an outer circumferential surface of the columnar connecting portion of the male terminal inserted into the cylindrical connecting portion.

4. The female terminal according to claim 1, further comprising:
a cylindrical contact member arranged on an inner circumferential side of the cylindrical connecting portion; and
an opening prevention member configured to restrict the first circumferential wall portion and the second circumferential wall portion mounted on an outer circumferential side of the cylindrical connecting portion from being displaced in a direction opposite to an opposed direction of the first circumferential wall portion and the second circumferential wall portion, wherein
the contact member has a plurality of spring contact portions configured to bias and come into contact with an outer circumferential surface of the columnar connecting portion of the male terminal inserted into the cylindrical connecting portion.

5. The female terminal according to claim 4, wherein
the opening prevention member includes a ring member made of metal notched in a location in a circumferential direction,
the cylindrical connecting portion has a plurality of engagement holes respectively provided to extend through the first circumferential wall portion and the second circumferential wall portion in a plate thickness direction, and
the ring member is arranged to cover outer circumferential-side openings of the plurality of engagement holes, and a plurality of engagement portions provided on the contact member respectively engage with inner circumferential-side openings of the plurality of engagement holes to position the contact member on the cylindrical connecting portion.

6. The female terminal according to claim 1, wherein
the first flat plate fitting has a first intermediate plate portion configured to couple the first circumferential wall portion and the first other end portion, and the second flat plate fitting has a second intermediate plate portion configured to couple the second circumferential wall portion and the second other end portion,
displacement of the first circumferential wall portion and the second circumferential wall portion to be spaced in a direction opposite to an opposed direction of the first circumferential wall portion and the second circumferential wall portion is allowed by elastic deformation of the first intermediate plate portion and the second intermediate plate portion, and
a biasing member configured to bias the first circumferential wall portion and the second circumferential wall portion in the opposed direction is mounted on the cylindrical connecting portion.

7. The female terminal according to claim 6, wherein
the biasing member includes a ring member made of metal notched in a location in the circumferential direction, and
an inner circumferential surface of the ring member is pressed against and mounted on an outer circumferential surface of the cylindrical connecting portion.

8. The female terminal according to claim 1, wherein
the cylindrical connecting portion is arranged to open toward a front side in a spacing direction from the wire connecting portion, and
the first circumferential wall portion and the second circumferential wall portion each include a slit which extends through in a plate thickness direction to open toward the front side in the spacing direction and a plurality of divided wall portions which are spaced from each other in the circumferential direction with the slit interposed therebetween.

9. The female terminal according to claim 1, wherein
the cylindrical connecting portion is arranged to open on both sides of the cylindrical connecting portion in an axial direction which is a direction orthogonal to a spacing direction from the wire connecting portion,
the first circumferential wall portion and the second circumferential wall portion each include a slit which extends in a plate thickness direction through an intermediate portion in the axial direction and a plurality of divided wall portions which are spaced from each other in the axial direction with the slit interposed therebetween, and
the plurality of divided wall portions of the first circumferential wall portion and the plurality of divided wall portions of the second circumferential wall portion are respectively arranged in an opposed manner to each other to configure a plurality of divided cylindrical portions arranged to be spaced from each other in the axial direction.

10. The female terminal according to claim 9, comprising
a plurality of biasing members corresponding to the plurality of divided cylindrical portions, wherein
each of the biasing members configured to bias the divided wall portions on the first circumferential wall portion side and the divided wall portions on the second circumferential wall portion side in the opposed direction is respectively mounted on each of the divided cylindrical portions.

11. The female terminal according to claim 4, wherein
the female terminal is configured to be stored in an insulating housing, the opening prevention member has a fitting portion to be fitted within a to-be-fitted portion provided in the housing, and the female terminal is positioned on the housing by fitting of the fitting portion within the to-be-fitted portion.

12. The female terminal according to claim 1, wherein
the first flat plate fitting and the second flat plate fitting are configured by a metal flat plate having a strip shape in which the first other end portion and the second other end portion are coupled to each other with a coupling portion interposed therebetween,
the first circumferential wall portion of the first flat plate fitting and the second circumferential wall portion of the second flat plate fitting are provided respectively in both end portions of the metal flat plate,
the coupling portion of the metal flat plate is bent in a plate thickness direction to overlap the first other end portion of the first flat plate fitting and the second other end portion of the second flat plate fitting on each other to configure the wire connecting portion, and the first circumferential wall portion and the second circumferential wall portion provided in both the end portions are arranged in an opposed manner to each other with a gap formed therebetween to configure the cylindrical connecting portion,
the first flat plate fitting has a first intermediate plate portion configured to couple the first circumferential wall portion and the first other end portion, and the second flat plate fitting has a second intermediate plate portion configured to couple the second circumferential wall portion and the second other end portion,
displacement of the first circumferential wall portion and the second circumferential wall portion to be spaced in a direction opposite to an opposed direction of the first circumferential wall portion and the second circumferential wall portion is allowed by elastic deformation of the first intermediate plate portion and the second intermediate plate portion,
a biasing member configured to bias the first circumferential wall portion and the second circumferential wall portion in the opposed direction is mounted on the cylindrical connecting portion,
the biasing member includes a ring member made of metal notched in a location in the circumferential direction,
an inner circumferential surface of the ring member is pressed against and mounted on an outer circumferential surface of the cylindrical connecting portion,
the cylindrical connecting portion is arranged to open toward a front side in a spacing direction from the wire connecting portion, and
the first circumferential wall portion and the second circumferential wall portion each include a slit which extends through in a plate thickness direction to open toward the front side in the spacing direction and a plurality of divided wall portions which are spaced from each other in the circumferential direction with the slit interposed therebetween.
